(19) United States
(12) Patent Application Publication
(10) Pub. No.: US 2024/0196806 A1
(43) Pub. Date: Jun. 20, 2024

(54) Bale Breaker and Bale Breaker Method

(71) Applicant: Heubatec GmbH, Leipzig (DE)

(72) Inventor: Frank Elsner, Bielefeld (DE)

(21) Appl. No.: 18/084,648

(22) Filed: Dec. 20, 2022

(51) Int. Cl. A01F 29/16; A01F 29/00; A01F 29/10; A01F 29/12; A01F 29/14; B02C 19/00; B02C 23/02; B02C 23/10

(52) U.S. Cl. CPC A01F 29/16; A01F 29/005; A01F 29/10; A01F 29/12; A01F 29/14; B02C 19/0006; B02C 19/0056; B02C 23/02; B02C 23/10

(57) ABSTRACT

The invention relates to a bale breaker (1) for a bale (2) of hay, straw, litter and/or fodder, comprising support means (3) for the bale (2) and breaker means (4) adapted to detach hay, straw, litter and/or fodder from a bale (2) provided on the support means (3) and to transport it to discharge means (5) arranged downstream of the breaker means (4), wherein feed means (6) for feeding a bale (2) provided on the support means (3) in a feed direction (Z) toward the disintegrating means (4) are associated with the support means (3), and wherein feed drive means (7) for driving the feed means (6) and disintegrating drive means (8) for driving the disintegrating means (4) are further provided, wherein control devices (9) are associated with the feed drive devices (7) and/or the opening drive devices (8) and/or the discharge devices (5), which are designed to control the feed drive devices (7) and/or the opening drive devices (8) and/or the discharge devices (5) in such a way that a malfunction or disturbance, such as in particular a jam or a blockage by the bale (2), in particular at the opening devices (4) and/or the discharge devices (5), is avoided or eliminated. Furthermore, the invention relates to a bale unraveling method in which a bale (2) of hay, straw, litter and/or fodder is transported on support devices (3) by means of their feed devices (6) driven by feed drive devices (7) to unraveling devices (4) driven by unraveling drive devices (8), which unravel hay, straw, litter and/or fodder from the bale (2) and transport it to output devices (5), wherein the feed drive devices (7) and/or the unraveling drive devices (8) and/or the dispensing devices (5) are controlled by means of control devices (9) in such a way that a malfunction or disturbance, such as in particular a jam or a blockage by the bale (2), in particular at the unraveling devices (4) and/or the dispensing devices (5), is avoided or eliminated.

The present invention relates to a bale breaker, disintegrator or opener according to the preamble of claim 1. Corresponding bale breaking, disintegrating or opening, litter and feed distribution methods can also be derived from this.

The invention relates to or is a technical device from the field of agricultural technology in particular, specifically the field of feed technology or stable technology, and performs or supports the following main tasks alternatively or in combination:
1. Breaking up bales of hay, straw and the like so that the material in the bale can be used as fodder or bedding for animal husbandry, e.g. horses, or
2. Dissolve or break bales of hay, straw and the like, so that the material of the bale can be supplied to an incinerator for energy or heat generation, for example, or for another use.

In particular, the present invention is based on a bale breaker from the same applicant according to DE 20 2016 008 248 U1, which emerged from EP 3 078 260 A1, and a bale breaker from the same applicant according to EP16000806.6, which emerged from WO2019/185078. With regard to the basics of bale breakers, their designs and functions, the contents and disclosures of these publications are hereby incorporated into the present application by reference.

Further publications on the basic technology are DE 195 10 215 A1, DT 25 35 204 A1, DE 27 15 269 A1 and DE 33 37 390 C1, the contents and disclosures of which regarding the basics for bale breakers, their designs and functions are hereby also incorporated by reference be included in the present application.

With bale breakers or shredders, jams, blockages and uneven or unwanted shredding results can occur. Furthermore, known bale breakers are often mechanically very complex, which drives up costs, manufacturing costs, wear, maintenance and susceptibility to failure. The aim of the present invention is to at least partially avoid or at least reduce these disadvantages.

To achieve this aim the invention provides a bale breaker according to claim 1 and a bale breaking method according to claim 9. Preferred and advantageous developments thereof are given in the dependent claims.

A bale breaker according to the invention for a bale of hay, straw, bedding and/or forage contains support devices for the bale and opener devices which are designed to separate and close hay, straw, bedding and/or forage from a bale provided on the support devices to transport output devices that are connected downstream of the opening devices, with the support devices being assigned feed devices for feeding a bale provided on the support devices in a feed direction towards the breaking or dissolving devices and with feed drive devices for driving the feed devices and opening drive devices for driving the dissolving devices are provided, wherein the supply drive devices and/or the dissolving drive devices and/or the output devices are assigned control devices which are designed, the supply drive devices and/or the dissolving drive to control the dissolving devices and/or the output devices in such a way that a malfunction or disturbance, such as in particular a jam or a blockage caused by the bale, in particular on the dissolving devices and/or the output devices, is avoided or rectified.

According to an advantageous and preferred development of such a bale breaker, it can be provided within the scope of the invention that at least one opening function sensor on the opening drive units and/or one output function sensor is assigned to the output units and the control units are designed to match the feed drive units and/or the opening drive units depending on at least one predetermined detection result of the at least one opening function sensor and/or the at least one output function sensor, which indicates a malfunction or fault or an imminent malfunction or fault caused by the bale at the opening devices or at the output devices can be closed, to be controlled in such a way that the malfunction or disturbance is temporarily counteracted, with each resolution function sensor and output function sensor preferably being a torque sensor, a motion sensor, e is a temperature sensor, a current or voltage sensor, or a switch.

Alternatively or additionally, according to the invention, it can advantageously and preferably be provided that the control devices are designed to trigger the feed drive devices, possibly depending on at least one predetermined detection result from the at least one opening function sensor and/or the at least one output function sensor, which a malfunction or fault or an imminent malfunction or fault caused by the bale at the opening devices or at the output devices can be inferred, to be controlled in such a way that the bale or material that has already been shredded is temporarily moved away from the opening devices or in the opposite direction to the direction in which the dust is removed or is temporarily moved more slowly in the feed direction towards the opening devices or more slowly in the dedusting direction in the output devices.

Furthermore, the invention creates advantageous alternative or additional developments of the bale breaker that are to be used with preference, consisting in that a bottleneck is connected upstream of the output devices in relation to the feed direction, which bottleneck is preferably formed by the opener devices or assigned to the opener devices and in particular is connected upstream.

A further advantageous embodiment of the invention is that the dissolving devices contain loosening devices, in particular possibly in the area of the bottleneck, for crushing lumps, pieces, chunks or slabs that have been released from the bale.

It can also preferably be provided that the dissolving devices contain drivers in the form of knives, blades, hooks, combs or rods, several of which are attached to a common rod-shaped carrier and, in particular, are integrally formed.

It can advantageously be provided that the output devices contain dedusting devices, in particular a dedusting duct, which preferably contains at least one perforated plate on the underside of the duct, through which unwanted material such as sand, loess, clay, etc. is separated and in which a discharge belt of the output devices runs.

Yet another advantageous and preferred embodiment is that a discharge belt of the output devices has dust carriers as entrainment devices in addition to entraining prongs and devices are preferably assigned to the output devices, by means of which an air flow is preferably transverse to the dedusting direction from a discharge belt of the output devices to the at least a perforated plate of the dedusting duct is generated in order to remove sand, loess, clay etc. from the hay, straw, bedding and/or feed through the perforated plate from the dedusting duct.

The invention also creates a bale opening method in which a bale of hay, straw, litter and/or fodder is transported on support devices by means of the feed devices driven by feed drive devices to the opening devices driven by opening drive devices, the hay, straw, litter and/or Remove feed from the bale and transport it to the output devices, with the feed drive devices and/or the opening drive devices and/or the output devices being controlled by means of control devices in such a way that a malfunction or disruption, such as in particular a jam or blockage by the bale, in particular at the Resolution devices and/or the output devices is avoided or remedied.

The bale opening method according to the invention can advantageously and preferably be further developed in various variants by the procedural use of the previously described further configurations of the bale breaker.

Further advantageous and preferred configurations result from the combination of individual claims, the following description of the figures for individual exemplary embodiments and the figures in the drawing.

The invention is explained in more detail below using exemplary embodiments with reference to the drawing, in which:

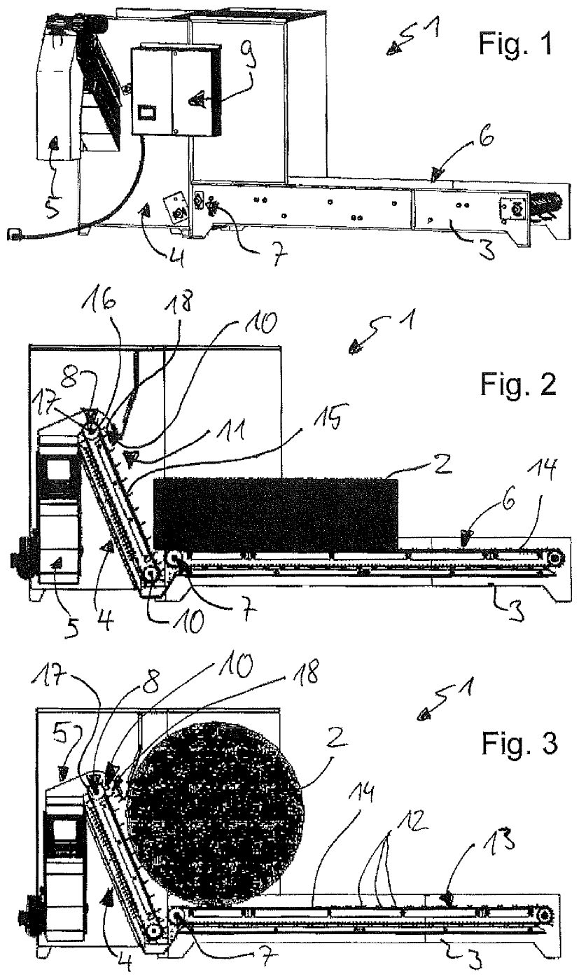

FIG. 1 shows in a perspective schematic view an embodiment of a bale breaker to clarify the components including a control,

FIG. 2 shows the exemplary embodiment of the bale breaker or shredder from FIG. 1 in a schematic open side view when processing a square bale,

FIG. 3 shows the exemplary embodiment of the bale breaker from FIG. 1 in a schematic open side view when processing a roll bale,

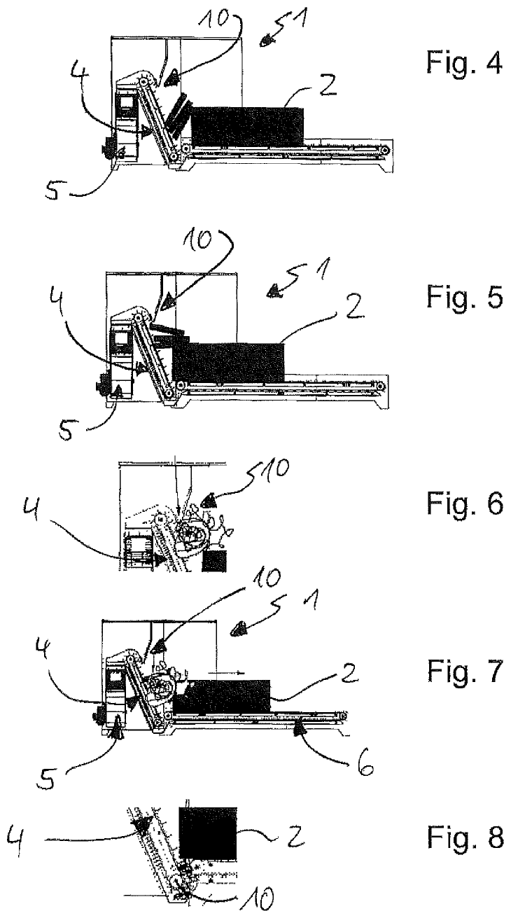

FIG. 4 is a schematic open side view of the embodiment of the bale shredder from FIGS. 1 and 2 when processing a square bale in an initial stage of processing,

FIG. 5 shows a schematic open side view of the exemplary embodiment of the bale shredder from FIGS. 1 and 2 during the processing of a square bale in an advanced stage of processing compared to the initial stage in FIG. 4,

FIG. 6 shows in a schematic, enlarged side view, a fault that has arisen from the stage in FIG. 5,

FIG. 7 shows a schematic open side view of the exemplary embodiment of the bale breaker from FIGS. 1 and 2 during the processing of a square bale in a later stage than the fault illustrated in FIG. 6 in order to resolve the fault,

FIG. 8 shows in a schematic enlarged side view a detail of the sequence of the resolution of the disturbance according to FIG. 7,

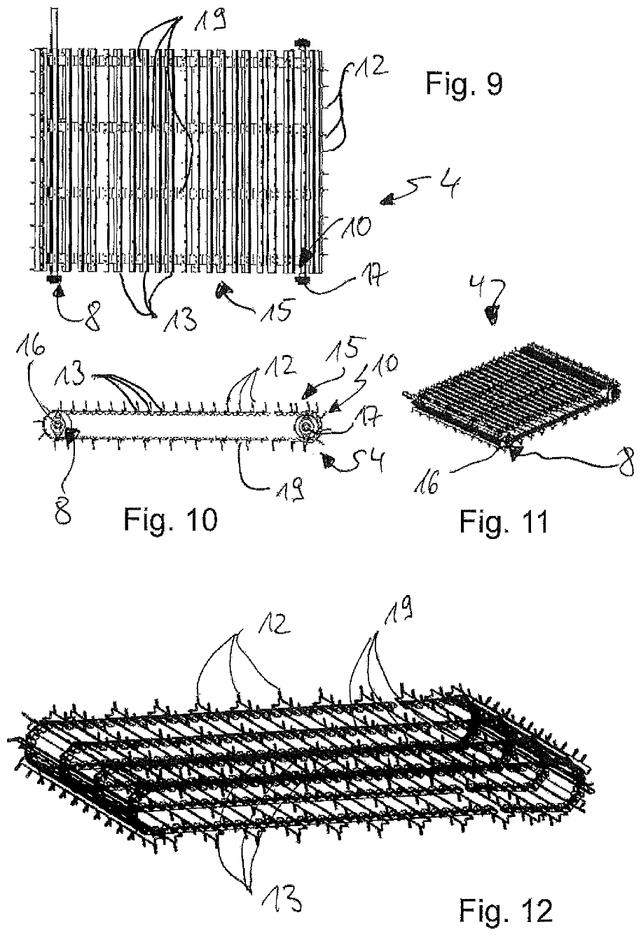

FIG. 9 shows a schematic plan view of a first exemplary embodiment of an opening chain as part of the opening devices of the bale breaker,

FIG. 10 shows a schematic side view of the first exemplary embodiment of the opening chain as part of the opening devices of the bale breaker according to FIG. 9,

FIG. 11 shows a perspective schematic view of the first exemplary embodiment of the opening chain as part of the opening devices of the bale breaker according to FIGS. 9 and 10,

FIG. 12 shows a perspective schematic view of a second exemplary embodiment of an opening chain as part of the opening devices of the bale breaker,

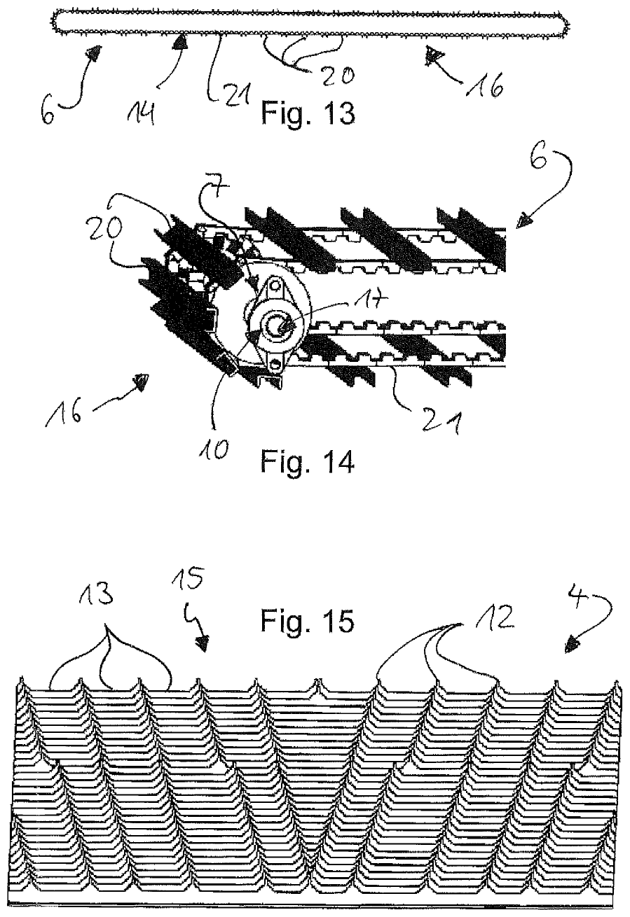

FIG. 13 shows a schematic side view of a first exemplary embodiment of a conveyor chain as part of the feed devices of the bale breaker,

FIG. 14 shows in a schematic, enlarged, partial side view of the exemplary embodiment of the conveyor chain as part of the feed devices of the bale breaker from FIG. 13,

FIG. 15 shows a perspective schematic view of a third exemplary embodiment of an opening chain as part of the opening devices of the bale breaker,

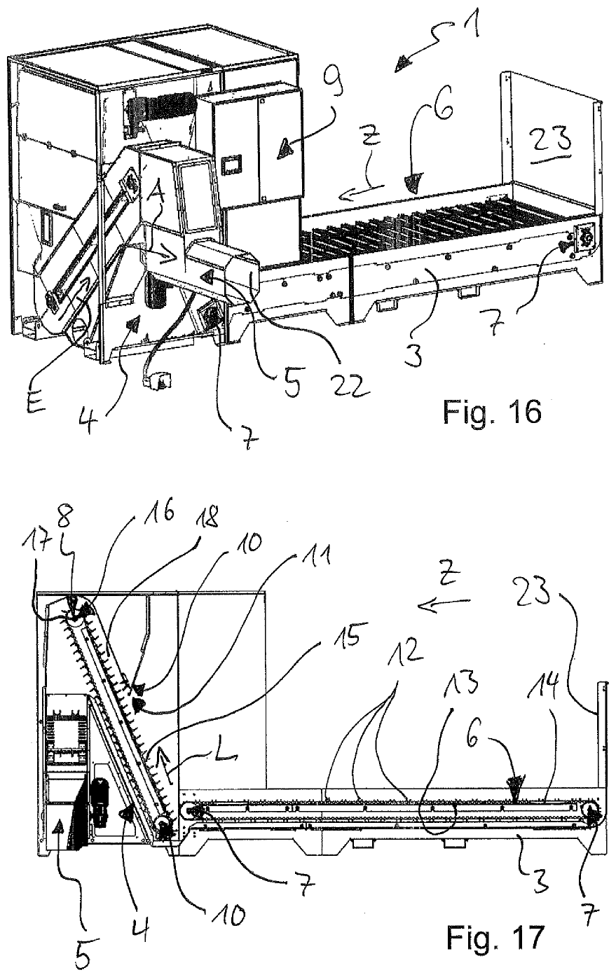

FIG. 16 shows a perspective schematic view of a further exemplary embodiment of a bale shredder to clarify the components including a controller,

FIG. 17 shows the further embodiment of the bale breaker from FIG. 16 in a schematic open side view,

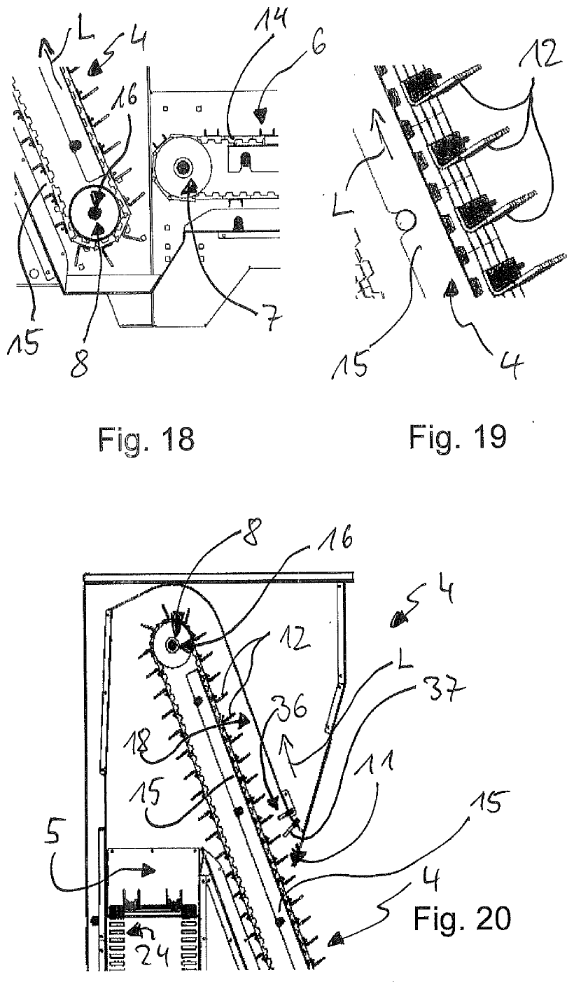

FIG. 18 schematically shows a first detail from FIG. 16,

FIG. 19 schematically shows a second detail from FIG. 16,

FIG. 20 schematically shows a third detail from FIG. 16,

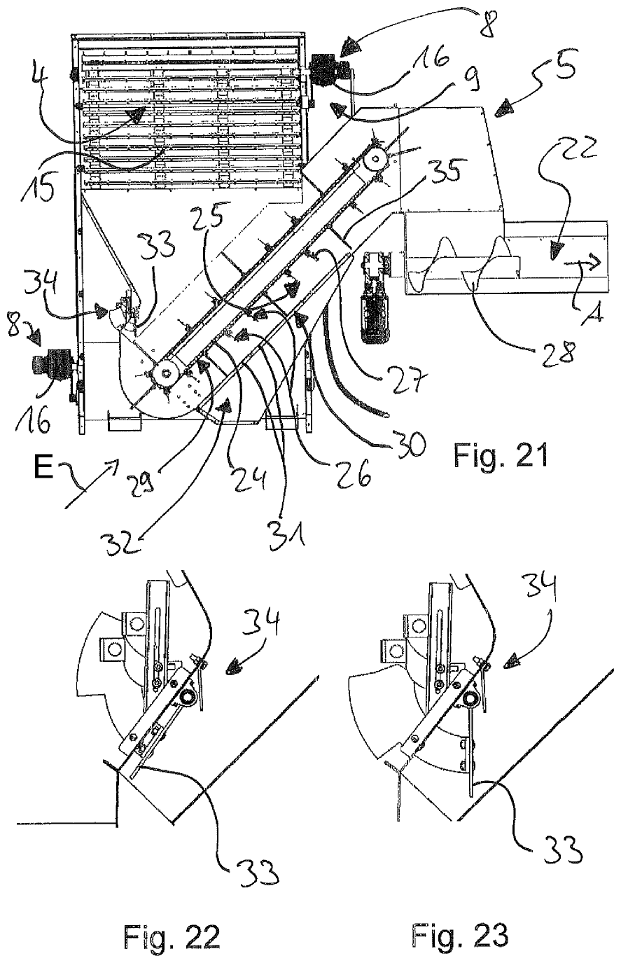

FIG. 21 shows the further exemplary embodiment of the bale breaker from FIG. 16 in a schematic, partially open front view,

FIG. 22 schematically shows an output function sensor from FIG. 20 in an actuated position,

FIG. 23 schematically shows the output function sensor from FIG. 22 in an unactuated position,

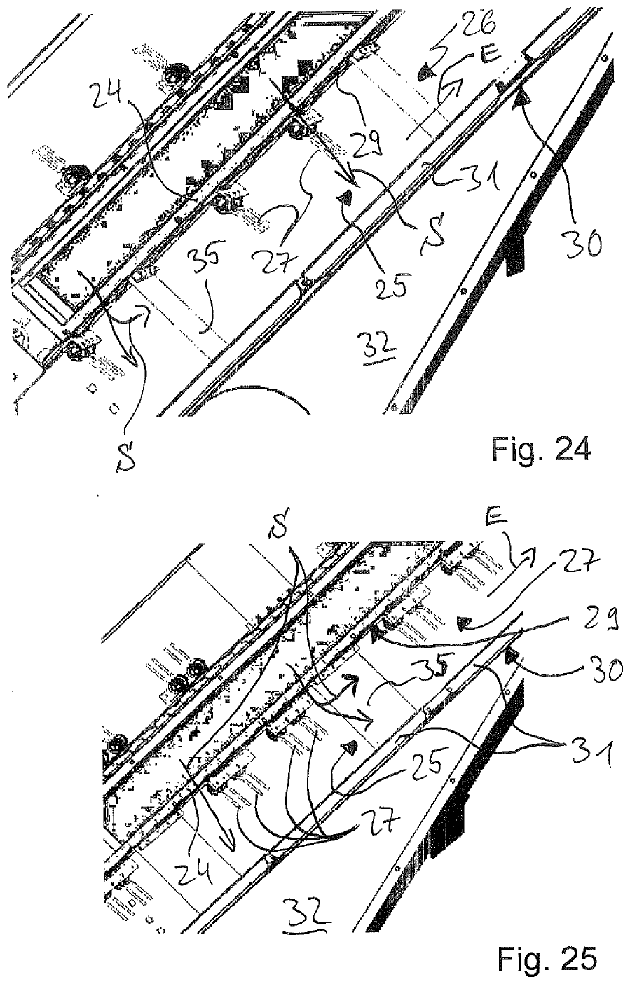

FIG. 24 shows a schematic of the dedusting devices of the bale breaker from FIGS. 16 and 21,

FIG. 25 schematically further details of the dedusting devices from FIG. 24,

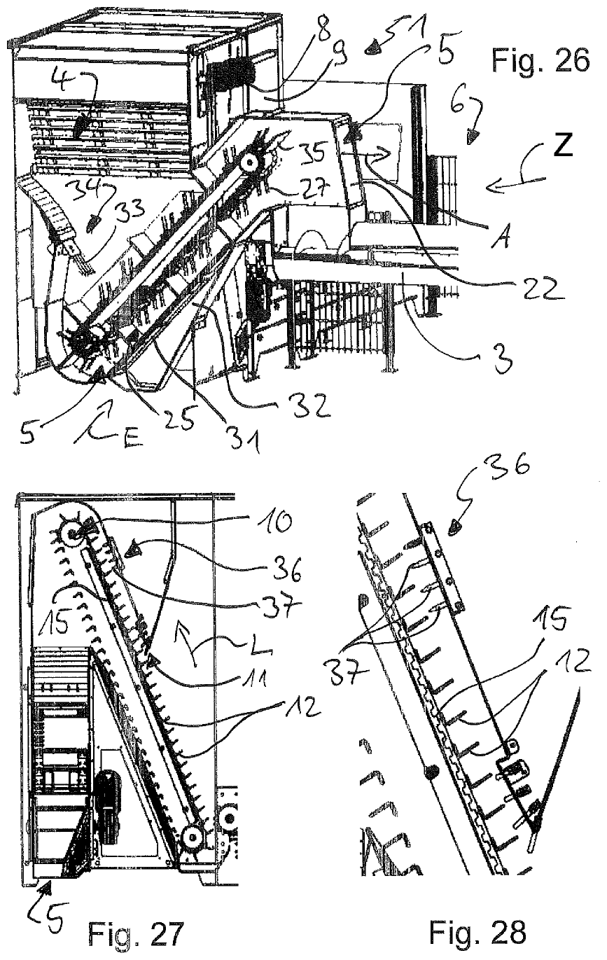

FIG. 26 shows in a perspective, schematic, partially open view yet another embodiment of a bale shredder to clarify the components,

FIG. 27 shows in a schematic partially opened side view a detail of yet another embodiment of the bale breaker from FIG. 26,

FIG. 28 shows schematically an enlarged detail from FIG. 27,

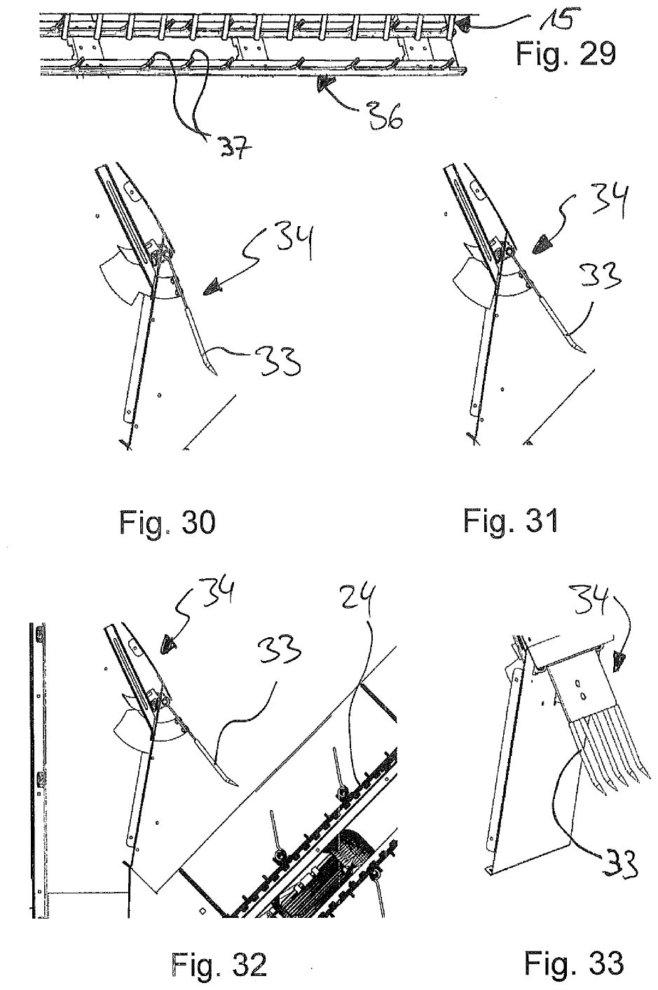

FIG. 29 shows a perspective, schematic bottom view of the opening chain as part of the opening devices of the bale breaker from FIG. 26,

FIG. 30 schematically shows an output function sensor from FIG. 20 in an actuated position,

FIG. 31 schematically shows the output function sensor from FIG. 30 in an unactuated position,

FIG. 32 shows schematically circumstances of the actuation of the output function sensor of FIGS. 30 and 31,

FIG. 33 shows the output function sensor from FIGS. 30, 31 and 32 in a perspective schematic view, and

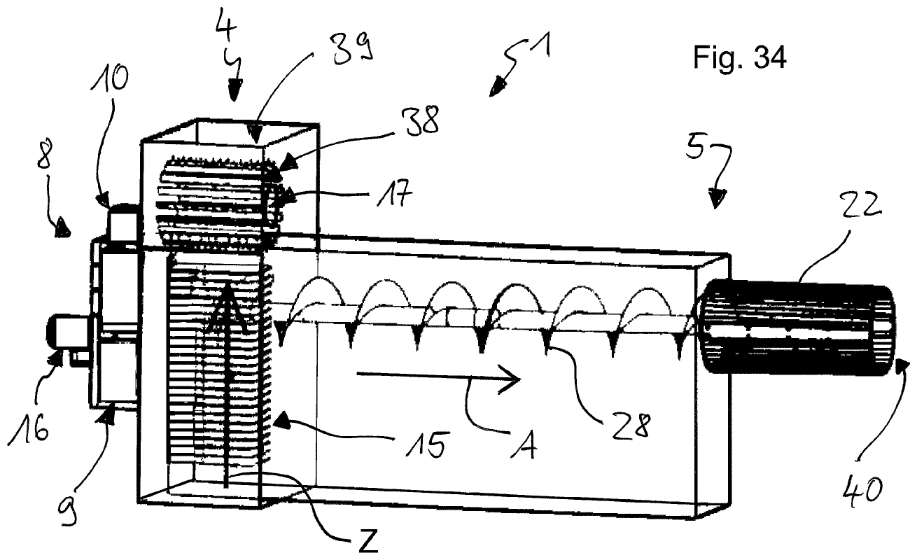

FIG. 34 shows a schematic perspective grid model view of yet another exemplary embodiment of a bale breaker in a particularly preferred embodiment.

On the basis of the exemplary embodiments and application examples described below and illustrated in the drawings, the invention is only explained in more detail by way of example, i.e. it is not limited to these exemplary embodiments and application examples. Process and device features also result analogously from device and process descriptions.

Individual features that are specified and/or shown in connection with a specific exemplary embodiment are not limited to this exemplary embodiment or the combination with the other features of this exemplary embodiment, but can, within the scope of what is technically possible, with any other variants, even if they are not dealt with separately in the available documents, can be combined.

The same reference symbols in the individual figures and illustrations of the drawing denote the same or similar components or components with the same or similar effect. The representations in the drawing also make clear those features that are not provided with reference symbols, regardless of whether such features are described below or not. On the other hand, features that are contained in the present description but are not visible or illustrated in the drawing can also be readily understood by a person skilled in the art.

The invention relates to or is a technical device from the field of agricultural technology, specifically the field of feed technology or stable technology, and performs or supports the following main tasks alternatively or in combination:
1. Breaking up bales of hay, straw, litter and/or fodder and the like so that the material in the bale can be used as fodder or bedding for keeping animals, e.g. horses, and/or
2. Dissolve bales of hay, straw, bedding and/or fodder and the like, so that the material of the bale can be fed to an incinerator for energy or heat generation, for example, or for another use.

A bale breaker or dissolver 1 for a bale 2 of hay, straw, bedding and/or fodder contains, as can be clearly seen in FIGS. 1 to 8, straw, litter and/or fodder from a bale 2 provided on the support devices 3 and to transport it to the output devices 5, which are connected downstream of the dissolving devices 4. The support devices 3 are assigned feed devices 6 for feeding the bale 2 provided on the support devices 3 in a feed direction Z towards the opening devices 4. In addition, feed drive devices 7 for driving the feed devices 6 and opening drive devices 8 for driving the opening devices 4 are provided. The feed drive devices 7 and/or the opening drive devices 8 are assigned control devices 9 (not shown in FIGS. 2 to 8) which are designed to control the feed drive devices 7 and/or the opening drive devices 8 in such a way that a malfunction or fault, such as a jam or blockage caused by the bale 2, in particular at the opening devices 4, is avoided or eliminated.

In the exemplary embodiment of the bale breaker 1 shown in FIGS. 1 to 8, at least one opening function sensor 10 is assigned to the control units 9 on the opening drive units 8 or the output units 5 and the control units 9 control the feed drive units 7 and/or the opening drive units 8 in Depending on at least one predetermined detection result of the at least one opening function sensor 10, which indicates a malfunction or fault or an imminent malfunction or fault caused by the bale 2 on the opening devices 4, so that the malfunction or fault is temporarily counteracted. The resolution function sensor 10 is preferably, for example or preferably, a torque sensor, a movement sensor, a temperature sensor, a current or voltage sensor.

In particular, in the exemplary embodiment of the bale breaker 1 according to FIGS. 1 to 8, it is provided that the control devices 9 control the feed drive devices 7, if necessary depending on at least one predetermined detection result from the at least one opening function sensor 10, which indicates a malfunction or fault or a impending malfunction or disturbance caused by the bale 2 at the opening devices 4 can be controlled in such a way that the bale 2 is temporarily moved away from the opening devices 4 counter to the feed direction Z or at times more slowly in the feed direction Z towards the opening devices 4 is moved.

Furthermore, in the exemplary embodiment of the bale breaker 1 according to FIGS. 1 to 8, a bottleneck is connected upstream of the output devices 5 in relation to the feed direction Z, which bottleneck is preferably formed by the opener devices 4 or assigned to the opener devices 4 and is in particular connected upstream.

Corresponding bale opening, bedding and feed distribution methods can also be derived from this, with the feed drive devices 7 and/or the opening drive devices 8 being controlled in such a way that a malfunction or disturbance, such as in particular a jam or blockage by the bale 2, in particular at the opening devices 4 is avoided or remedied. The aforementioned configurations with the control devices 9 and preferably the at least one resolution function sensor 10 as well as their operation and effects are procedurally integrated.

In the following, further examples and details of the bale breaker 1 as well as its configuration and function according to the invention are explained further as further exemplary embodiments, in particular with reference to FIGS. 4 to 8.

For the sake of completeness, it is pointed out that the bale breaker 1 in FIG. 1 is provided with a casing or housing (not labeled), which has been omitted in FIGS. 2 to 8.

The bale 2 lying on the feed devices 6, such as a conveyor belt 14, is driven at a predetermined and, in particular, suitably adjusted speed against the opening devices 4, which contain, for example, an opening chain 15. On/on the opening chain 15 there are knife-, blade-, hook-, comb- or rod-shaped carriers 12, several of which are arranged on a common rod-shaped carrier 13 and are in particular integrally formed, of which a plurality in turn are preferably at least approximately the same Distances are attached to the dissolving chain 15, which preferably circulates in a closed circuit. The knife-, blade-, hook-, comb- or rod-shaped carriers 12 “grip” into the bale 2 fed from the feed devices 6 to the opening devices 4 and loosen it, depending on the feed or conveying speed of the conveyor belt 13, more or less Material, i.e. hay, straw, bedding and/or fodder, from the bale 2 thus breaks up the bale 2 and conveys this material in the direction of a constriction 11, as illustrated in FIG.

The torque of a drive motor 16 of the opening drive devices 8 of the opening chain 15 is measured via a frequency converter 17 which takes over the function of an opening function sensor 10. The measurement result from the frequency converter 17 or, in general, the resolution function sensor 10 is forwarded to the control device 9, in particular continuously or at predetermined or predeterminable time intervals, where these measured values are compared as actual values with predetermined or predeterminable setpoint values in order to identify a malfunction or fault or to determine an imminent malfunction or fault in the case of a specified or specified deviation or change over time between the actual value and the setpoint.

In this way, the control devices 9 can determine that, for example, the pressure derived from the measured values, which is exerted by the supplied bale 2 on the opening chain 15, exceeds the pressure that corresponds to a specific setpoint value, with the apparatus thus indicating that a predetermined value has been exceeded defined value of the torque of the drive motor 13 is present. In such a case, the control devices 9 control the conveyor belt 14 of the feed drive devices 7 backwards, i.e. counter to the feed direction Z, and thereby relieve the opening chain 15. As soon as the torque falls below the “critical” again, the control devices 9 control the feed drive devices 7 again Operation in the feed direction Z, so that the conveyor belt 14 runs towards the opening chain 15 again. During this temporary reversal of the direction of movement of the feed drive devices 7 and thus of the conveyor belt 14, the opening chain 15 of the opening devices 4 continues to run, in particular towards the bottleneck 11 and towards the output devices 5. Alternatively or additionally, the controller 9 can also stop the drive motor 16 of the opening chain 15 of the opening devices 4 or reverse it in order to eliminate a malfunction or fault or to prevent an imminent malfunction or fault.

Among other things, the speed of the opening chain 15 of the opening devices 4 is of decisive importance for the conveyed quantity. In this case, this speed moves within certain tolerances, which can easily be more precisely defined in tests without own inventive requirements. If the speed is too high, the material to be conveyed, in particular hay, but also straw, litter and/or fodder, is shredded/torn into small parts that are too small for the intended use. If the speed is too low, lumps and chunks etc. will be loosened from the bale 2, i.e. no “optimally loosened” material will be obtained. Material-dependent speeds are also conceivable, e.g. high speeds with straw and medium speeds with hay. Successful tests for all possible materials were carried out on average at speeds in the range of about 900 mm/s to about 1000 mm/s, in particular about 942 mm/s, depending on the material and in particular its condition without any inventive Activity can be optimized. These speeds of the opening chain 15 of the opening devices 4 were successfully tested in our own tests with speeds of the conveyor belt or the conveyor chain 14 of the feed devices 6 in the range from 2 mm/s to 20 mm/s and in particular from about 8 mm/s to about 12 mm/s, but also combined with optimal material of the bale without malfunctions or disturbances with approximately 4.16 mm/s. With this, for example, a cuboid bale 2 made of hay and/or straw with a length of 2500 mm can be broken up within or even in less than ten minutes. In order to compensate in particular for forward/backward cycles of the conveyor belt or conveyor chain 14 of the feed devices 6 and/or the opening chain 15 of the opening devices 4, which can occur depending on the material, the speeds can be correspondingly increased or higher, which is preferably done via the control devices 9 is adjustable.

Depending on the e.g. a defined torque acting on the detaching chain 15, the conveyor belt or the conveyor chain 14 of the feed devices 6 runs backwards induced by the control devices 9 in order to relieve the detaching chain 15 of the detaching devices 4 and thus the detaching drive devices 8 in corresponding situations, and at the same time to prevent the hay or straw in particular from being crushed to an undesirable degree by excessive pressure/excessive pulling forces of the knife-, blade-, hook-, comb- or rod-shaped carriers 12 of the disintegrating chain 15 of the disintegrating devices 4 on the bale 2.

If the defined torque of the loosening chain 15 of the loosening devices 4 is undershot, the conveyor belt or the conveyor chain 14 of the feed devices 6 runs again in the feed or conveying direction Z against the loosening chain 15 of the loosening devices 4 as a result of the control devices 9. During this process, the material already loosened from the bale 2 is conveyed by the loosening chain 15 of the loosening devices 4 in the direction of the bottleneck, bottleneck or bottleneck point 11. Such more or less large-volume, disintegrated and loosened material is then compacted again when it enters a closed channel 18 of the disintegration devices 4 created at the bottleneck or bottleneck 11. The resulting pressure also exerts forces on the disintegration chain 15 of the disintegration devices 4. When the defined torque of the drive motor 16 of the dissolving chain 15 of the dissolving devices 4 is consequently exceeded, the control devices 9 first move the conveyor belt 14 of the feed devices 6 back again as described above, i.e. against the feed direction Z, and or the drive motor 16 of the dissolving chain 15 of the dissolving devices 4 is temporarily steered backwards.

Under certain conditions which can be determined without any inventive activity of their own, and which can be determined by means of the control devices 9 as a function of the torque measured in real time and the time, it is then also possible, for example, as has already been described, for the pulping chain 15 of the pulping devices 4 to be operated by the control devices 9 in reverse, i.e. leading away from the output devices 5, in order to fall below the defined torque again. Due to the space freed up by the retraction of the conveyor belt 14 of the feed devices 6, the material compacted at the bottleneck or bottleneck 11 can relax and is conveyed away from the bottleneck or bottleneck 11 by the reverse operation of the pulping chain 15 of the pulping devices 4 or, with the appropriate setup, simply falls downward, as illustrated in FIG. 8.

After the defined torque of the disintegrating chain 15 of the disintegrating devices 4 has been undershot, it runs again in the conveying direction, i.e. towards the feeding devices 5, in accordance with the feed direction Z of the conveyor belt 14 of the feeding devices 6, prompted by the control devices 9. Since the unraveling chain 15 of the unraveling devices 4 runs in particular at a significantly higher speed than the conveyor belt 14 of the feeding devices 6, the time should be sufficient to convey the already unraveled loosened material through the bottleneck or bottleneck 11 into the closed channel 18 before possibly the bale 2 runs again through the conveyor belt 14 of the feeding devices 6 against the unraveling chain 15 of the unraveling devices 4 and also builds up pressure again at this point.

The indicated times and speeds of the individual elements, which is realized by the control devices 9, can be optimized in experiments without own inventive activity. A goal aimed at in the own experiments is an output of e.g. at least 30 kg hay per minute. Furthermore, the forward/reverse movements of the unraveling chain 15 of the unraveling devices 4 and the conveyor belt 14 of the feeding devices 6 are intended to achieve that hay in particular is unraveled “gently” and is preserved as far as possible in length and structure, which can be achieved precisely by the design, setting and operation of the control devices 9.

In the bale breaker 1 for a bale 2 of hay, straw, litter and/or fodder, with support devices 3 for the bale 2 and opening devices 4, which are designed to open hay, straw, litter and/or fodder from a bale 2 provided on the support devices 3 and to transport it to delivery devices 5, which are connected downstream of the opening devices 4, wherein feed devices 6 for feeding a bale 2 provided on the support devices 3 in a feed direction Z to the dissolving devices 4 are associated with the support devices 3, and wherein furthermore feed drive devices 7 for driving the feed devices 6 and dissolving drive devices 8 for driving the dissolving devices 4 are provided, it can also be provided without the control devices 9 with the advantage that the dissolving devices 6 contain knife-shaped, blade-shaped, hook-shaped, comb-shaped or rod-shaped carriers 11, several of which are attached to a common rod-shaped carrier 12 and in particular are integrally formed.

Preferably, the knife-, blade-, hook-, comb- or rod-shaped carriers 11 are integrally formed with carriers 12, which in turn are attached at preferably approximately equal intervals to a circulating release chain 15 of the release devices 4, so that combinations with other elements such as threaded rods, nuts, clamps and belts on the release chain 15 of the release devices 4 are avoided as far as possible or to the greatest extent possible and thus a cost-effective design is achieved. Examples thereof are illustrated in FIGS. 9 to 12 and 15.

Preferably and advantageously, the knife-, blade-, hook-, comb- or rod-shaped carriers 11 consist of lased and edged angles which also form the supports 12 and in whose legs pointing away from the release chain 15 of the release devices 4 the contours of the actual knife-, blade-, hook-, comb- or rod-shaped carriers 11 are lasered, as can be seen well in FIG. 12, for example. The lasered knife-, blade-, hook-, comb- or bar-shaped carriers 11 together with carrier 12 are only connected with, for example, belts 19 to form a detaching chain 15 of the detaching devices 4, for example, screwed together or otherwise suitably connected.

Almost from the first start of the bale breaker 1, except for a short delay until the mes-ser-, blade-, hook-, comb- or bar-shaped carriers 11 have engaged, a bale 2 runs through almost constantly in terms of quantity, regardless of the material.

Preferably, the sum of the individual lasted knife-, blade-, hook-, comb- or rod-shaped carriers 11 on the lasted and edged carriers 12 over the width of the opening chain 15 of the opening devices 4, seen from the front, results in an almost closed front. As a result, the bale 2 is processed over essentially its entire width. Also possible are other designs and arrangements of the individual lasted knife-, blade-, hook-, comb- or rod-shaped carriers 11 on the lasted and edged carriers 12 over the width of the opening chain 15 of the opening devices 4, as e.g. FIG. 15 illustrates, in which an arrow-shaped design and arrangement of the individual latched knife-, blade-, hook-, comb- or rod-shaped carriers 11 on the lasered and edged carriers 12 in the course of the opening chain 15 of the opening devices 4 is shown in the conveying direction. A zigzag design and arrangement has also been successfully tested. The spacing of the lasered and edged carriers 12 with knife-, blade-, hook-, comb- or rod-shaped carriers 11 on the unraveling chain 15 of the unraveling devices 4, viewed in a planar region, is about 40 mm to about 120 mm, in particular about 60 mm to about 100 mm and preferably about 80 mm.

An example of a conveyor chain or belt 14 of the feeding devices 6 with U-profiles 20 on belts 21, which may be identical, for example with respect to make and material, to the belts 19 of the unraveling chain 15 of the unraveling devices 4, is illustrated in FIGS. 13 and 14. E.g., but not limitingly, DIN 1026 C-steel with in cross-section 40 mm×20 mm is used for these U-profiles 20.

In FIGS. 16 to 25, a further embodiment example of a bale breaker 1 is illustrated together with special designs and details. Insofar as this further embodiment example is or can be identical, similar or functionally identical with respect to embodiments according to FIGS. 1 to 15, this will be omitted in the following in order to avoid mere repetition. In particular, also on the basis of the reference signs in FIGS. 16 to 25, the identical, similar or functionally identical components from FIGS. 1 to 15 can be identified without further ado and are readily understandable to the person skilled in the art even without repetition of corresponding descriptions for FIGS. 1 to 15, to which reference is hereby made explicitly correspondingly and in particular with expert understanding for FIGS. 16 to 25.

The illustrations of the further embodiment of the bale breaker 1 in FIGS. 16 and 17 are largely identical to the illustrations in FIGS. 1 and 2 and 3, respectively, except for an at least substantially horizontally extending dispenser 22 of the dispensing devices 5 in FIG. 16 and the missing bale 2, but an additional end wall 23 on the feeding devices 6 at the other end relative to the opening devices 4 in order to prevent a bale 2 or hay, straw, litter and/or fodder from falling down.

In FIGS. 16 and 17, the feed direction Z, the breaking or release direction L, a dust removal direction E and the discharge direction A are also shown with correspondingly marked arrows.

FIG. 18 shows schematically in detail from FIG. 16 the interface between the conveyor belt 14 of the feed devices 6 and the detaching chain 15 of the detaching devices 4. FIG. 19 shows schematically in detail the knife-, blade-, hook-, comb- or rod-shaped carriers 12 of the detaching chain 15 of the detaching devices 4 in this further example of execution. The upper end of the detaching chain 15 of the detaching devices 4 opposite the interface between the conveyor belt 14 of the feed device 6 and the detaching chain 15 of the detaching devices 4 is schematically illustrated in FIG. 20 with components arranged there, the explanations of which can be readily recognized and understood by comparative observation with FIGS. 1 to 15 and the associated descriptions.

Although also present in the embodiment example according to FIGS. 1 to 8, a discharge belt 24 of the dispensing devices 5 is dealt with in more detail here in connection with the further embodiment example according to FIGS. 16 to 25 due to special designs. The arrangement of this discharge belt 24 can be clearly seen in FIG. 21. Like the unraveling chain 15 of the unraveling devices 4, the discharge belt 24 of the discharge devices 5 also runs diagonally from bottom to top. However, the hay, straw, litter and/or fodder detached from the bale 2 is not conveyed on top of the detaching chain 15 of the detaching devices 4 as in the case of the detaching chain 15, but is conveyed within a decongestion channel 25 by entraining devices 26, such as, for example, entraining tines 27 on the discharge device 5. The hay, straw, litter and/or fodder, which has now been loosened and, as will be explained below, dedusted, is discharged at the open end of the discharge conveyor 22.

At the interface between the conveyor belt 14 of the feeding devices 6 and the loosening chain 15 of the loosening devices 4, which is shown schematically enlarged in detail in FIG. 18, in addition to hay, straw, litter and/or fodder loosened out of the bale 2, material in the form of sand, solvent, clay, etc., which is inevitably contained in the bale 2, also lands. This material is purposefully undesirable in the hay, straw, litter and/or forage product that is ultimately dispensed, and also causes undesirable air pollution as it flies around. After the hay, straw, litter and/or forage, together with sand, looseness, clay, etc., has fallen from the upper end of the unraveling chain 15 of the unraveling devices 4 in front of or onto the lower end of the discharge belt 24 lying below it, it is gripped by the entrainment tines 27 thereof and transported upwardly by the discharge belt 24 until it falls onto the discharge screw 28 at the upper end of the latter and is discharged by the latter in the dispenser toward the open end thereof.

The discharge belt 24 runs in a dedusting channel 25 as illustrated by the arrow of the dedusting direction E. That is, the underside 29 of the discharge belt 24 moves from bottom to top. As a result, the hay, straw, litter and/or fodder together with sand, sol, clay, etc. is pushed by the entrainment tines 27 of the discharge belt 24 over a channel underside 30 of the dedusting channel 25. This channel underside 30 of the dedusting channel 25 contains or is formed by perforated plate(s) 31, through the holes of which (not shown) sand, looseness, clay etc. falls and is preferably even sucked off. Advantageously, particularly in order to prevent sand, looseness, clay, etc. from being stirred up into the ambient air and also to prevent “false air” from impairing the extraction flow during the preferential extraction, the discharge belt is arranged in the closed dust extraction duct 25. Thus, due to the “unusual” running direction of the discharge belt 24 and the transport of hay, straw, litter and/or fodder including sand, looseness, clay etc. realized thereby, precisely the undesired material in the form of sand, looseness, clay etc. is separated. The fact that this takes place in the closed dust removal duct 25 effectively prevents sand, sol, clay, etc. from escaping into the ambient air. The unwanted material in the form of sand, sol, clay, etc., thus separated can then be readily collected in a collection container or dust bin 32 and, when this has reached a predetermined fill level, can be put to its own environmentally sound use, such as planting soil.

In order to prevent hay, straw, litter and/or fodder together with sand, looseness, clay, etc., from being chopped up in the discharge conveyor 24 in the dust removal channel 25 and clogging the dust removal channel 25 as well as obstructing the discharge conveyance, a discharge switch 33 is advantageously associated with the lower end of the discharge conveyor 24. This is a simple mechanical solution for preventing clogging or obstruction of the discharge in the dust removal channel 25. Such a discharge switch 33, which is an example of a general output function sensor 34, is shown schematically in FIG. 22 in an actuated position and in FIG. 23 in an unactuated position. Both the “actuated” and “unactuated” positions of the switch shown in FIGS. 22 and 23, where the switch is also already shown in FIG. 21, as well as other sensors for detecting or indicating a functional obstruction or malfunction of the discharge belt 24 in the dust removal channel 25 and thus the output are at the discretion of the skilled person, for whom this advantageous aspect of the present invention is sufficiently clear on the basis of the version disclosed here of a detection of a functional obstruction or malfunction of the discharge belt 24 in the dust removal channel 25.

The discharge switch 33 of the discharge belt 24 prevents an overfilling of the latter and the dust removal channel 25 and thus a compaction of the conveyed material, i.e. hay, straw, litter and/or fodder together with initially sand, loosen, clay etc.. It is ensured by the discharge switch 33 or generally a suitable discharge function sensor 34 that hay, straw, litter and/or fodder together with initially sand, looseness, clay etc. is transported sufficiently loosely in the dust removal channel 25 through the discharge belt 24 via the perforated plates 31 or generally separation devices obliquely from the bottom to the top and falls into the collection container or dust container 32 or is even sucked in. Fine dust, i.e. very fine dust which otherwise contaminates the ambient air with haze, can thus be optimally avoided and, if necessary, extracted. Details are also shown schematically in FIGS. 24 and 25.

Via the dust extraction duct 25, which may also function as a quasi-suction hood, the fine dust from the loose hay, straw, litter and/or fodder together with the initial sand, looseness, clay, etc. is effectively extracted in an optimized design. Suitable supply air openings (not shown) allow clean air to flow through the hay/straw and promote the extraction effect and prevent false air. The supply air required for the extraction is advantageously supplied as an air flow through the discharge belt 24, as illustrated in FIGS. 24 and 25 with arrows as supply air flow S.

As a further embodiment, as is also illustrated in FIGS. 24 and 25 and also 21, it may further be provided that dust drivers 35 are also provided on the discharge conveyor 24 in addition to the driving tines 27. For example, every third entraining tine 27 is replaced by a dust entrainer 35 made of rubber, for example, as is illustrated in the example of FIGS. 21 and 24 and 25. The dust drivers 35 are adapted in size and shape to the free space between the underside 29 of the discharge belt 24 and channel underside 30 of the dedusting channel 25, have a suitable rigidity, but are not absolutely rigid. In terms of suction, the dust collectors 35 divide the discharge belt 24 into several sectors closed in the direction of movement of the latter, i.e. in the dedusting direction E. In this way, supply air can be directed in a targeted manner from top to bottom in the form of, in particular, clean air preferably from the surroundings (e.g. via a blower, which is not shown) into the closed sectors moving along with the discharge belt 24. Thus, when combined with a suction system, the dust entrainers 35 have two functions, namely, in addition to physically entraining dust and the like so that it can fall through the perforated plates 31, they also have a guiding function for compressed air to further promote and enhance the escape of dust and the like through the perforated plates 31. In the case of a use of compressed air, the dust drivers 35 further prevent the suction and entry of false air from the environment, which moreover also again introduce additional dust and the like into the treated material of hay, straw, litter and/or fodder together with initially sand, sol, clay etc., which is just effectively prevented by these dust drivers 35.

In FIG. 26, still another further embodiment example of a bale breaker 1 is shown in a perspective schematic partially opened view similar to the further embodiment example of the bale breaker 1 illustrated in FIG. 16, with further advantageous and/or preferred embodiments thereto being schematically illustrated in FIGS. 27 to 33. Insofar as this still further embodiment example is or can be identical, similar or functionally identical with respect to embodiments according to FIGS. 1 to 15 as well as FIGS. 16 to 25, this will be dispensed with below in order to avoid mere repetition. In particular, also on the basis of the reference signs in FIGS. 26 to 33, the identical, similar or functionally identical components from FIGS. 1 to 25 can be identified without further ado and are readily comprehensible to the person skilled in the art even without repetition of corresponding descriptions for FIGS. 1 to 25, to which reference is hereby made explicitly accordingly and in particular with expert understanding for FIGS. 26 to 33.

A specific embodiment in the still further embodiment of the bale breaker 1 according to FIG. 26 is illustrated in FIGS. 27, 28 and 29. Statically or fixedly mounted loosening devices 36 in the form of, for example, pins 37 are suitably mounted above the part of the loosening chain 15 moving in the loosening direction L, which ensure that lumps of hay, straw, litter and/or fodder, together with sand, loosening agent, clay, etc., carried along by the loosening chain 15 are further broken up and thus the loosening result of the material is further improved. Such lumps or pieces, chunks or lumps of material can be broken up at the material inlet to the pulping devices 4, i.e. at the interface between the conveyor belt 14 of the feeding devices 6 and the pulping chain 15 of the pulping devices 4, among others. can also be torn out of the bale 2 depending on the clearance height of this material inlet and can negatively influence the opening result and also prevent a dust separation, as shown and described in connection with the further embodiment example according to FIGS. 16 to 25 and as it is also realized with advantage and preference in the still further embodiment example now dealt with, together with suction, from being optimally effective. FIG. 29 illustrates the arrangement, design and bearing of the pins 38 in relation to the release chain 15 from the underside thereof.

FIGS. 30 to 33 illustrate a further specific embodiment in the still further embodiment example of the bale breaker 1. FIGS. 30 and 31 each schematically show the discharge switch or switches already explained in connection with the further embodiment example of the bale breaker 1 according to FIGS. 16 to 25 in an actuated position (FIG. 30) and in an unactuated position (FIG. 31), the schematic circumstances of the actuation of the discharge switch 33, which generally represents an output function sensor 34, being made clear by the illustration in FIG. 32. In the two embodiment examples according to both FIGS. 16 to 25 and FIGS. 26 to 33, the discharge switch 33 or generally output function sensor 34 ensures that a material jam and/or a malfunction in the discharge belt 24 is prevented or eliminated, in that various actions can be triggered in dependence on the discharge switch 33 in the actuated position or generally a state detection of the output function sensor 34 and can be implemented by the controller 9. For example, the discharge belt 24 can be stopped and possibly even temporarily steered backwards, i.e., against the direction of dust removal E. The pulping chain 15 can also be stopped and possibly even temporarily steered backwards, i.e. against the pulping direction L. In particular, these two actions may be combined in coordinated predeterminable or predetermined routines to dissolve a buildup of material which may have occurred at the lower end of the discharge conveyor 24 and may interfere with the operation of the latter.

An output function sensor 34 is generally used to detect a malfunction or impairment of the discharge conveyor 24, and possibly and, if applicable, also of the dedusting as a result of a defined force on the discharge belt 24 being exceeded, just as each opening function sensor 10 serves to prevent a malfunction or impairment of the opening chain 15 as a result of a defined force on the latter being exceeded, and thus to make situation information available to the control 9, by means of which this control 9 then appropriately controls the feed devices 6, the dissolving devices and/or the output devices 5 in order to avoid or remedy impairments or optimally incipient impairments, wherein the core of the present invention consists.

As can already be seen from FIGS. 30 to 32, FIG. 33 shows in detail the design and, in particular, the shape of the discharge switch(es) 33. The slightly angled shape of the discharge switch(es) 33 ensures that any excess of hay, straw, litter and/or fodder, including sand, loosened material, clay, etc., which is released by the loosening devices 4 and may have been loosened, for example, by the loosening devices 36, is diverted upwards, which would then not fit into the dedusting duct 25 in terms of volume, is discharged upwards. If more than a predetermined or specifiable amount of material accumulates on the discharge switch 33, this is pressed down and triggered by the weight of this material, which in turn is “communicated” to the control unit 9, which then stops, in particular at least temporarily, the subsequent conveying of hay, straw, litter and/or fodder together with sand, looseness, clay, etc., until the discharge switch 33 is free again. In this way, in addition to functional reliability and trouble-free operation of the bale breaker 1 as a whole, it is achieved that only very loose hay, straw, litter and/or fodder is located in the dust removal channel 25, which not only positively influences the final result of the ultimately discharged end product, but also enables or favors optimum dust removal, because fine, volatile dust and the like can be optimally extracted in particular with such material. If the hay, straw, litter and/or fodder together with sand, sol, clay, etc. were compacted in the dedusting channel 25, the cleaning effect would be weaker.

By the embodiment according to the invention, i.e. the control devices 9, which are designed to control the feed drive devices 7 and/or the dissolving drive devices 8 and/or the discharge devices 5 in such a way that a malfunction or disturbance, such as, in particular, a jam or a blockage by the bale 2, in particular at the disintegrating devices 4 and/or the dispensing devices 5, is avoided or eliminated, it is achieved that hay, straw, litter and/or fodder can be disengaged from the bale 2 gently and without itself becoming dusty or crumbly and made available in a suitable manner as litter or fodder material. Advantageously, according to the variant with separation and, if necessary, suction, in the loosened hay, straw, litter and/or fodder, an undesirable proportion of sand, sol, clay, etc. can be removed from the end product itself on the one hand, and on the other hand also from the litter or fodder material. on the one hand in the end product itself and on the other hand also as fine dust in the ambient air, which fine dust normally arises when working and shaking up hay, straw, litter and/or fodder and contaminates the ambient air as a “haze cloud/dust cloud”, can be avoided, which increases the product quality and at the same time significantly improves the working conditions when providing this end product.

The following features are advantageous and preferably realized embodiments and achievable advantages of a bale breaker 1 according to the invention:
1. the arrangement of the individual components as a whole
2. the shape of the blades of the discharge chain as entrainers of “coarse/heavy dust
3. the entrainment tines to loosely transport the conveyed hay and straw
4. the dust drivers, for example made of rubber, to transport coarse/heavy dust and to enable a targeted suction from top to bottom (approx. 220 mm)
5. the switch of the discharge belt to prevent overfilling of the discharge belt and consequent compaction of the material to be cleaned off
5. the supply air opening as such and the arrangement of the supply air opening directly above the raw material.

In FIG. 34, a further embodiment of the bale breaker 1 is schematically illustrated in a perspective view in a particularly preferred embodiment. Insofar as components have already been explained above, reference is made in full to the corresponding details both in text details and illustrations in the other figures of the drawing in order to avoid mere repetition. In FIG. 34, some components are not visible for the clarity of the illustrations of the bale breaker, but these are clear by comparison or combination with the other figures of the drawing.

Of the bale breaker 1 in the schematic perspective view of FIG. 34 are shown and characterized:
unraveling devices 4,
output devices 5,
unraveling drive devices 8,
control devices 9,
a dissolving function sensor 10,
a dissolving chain 15,
a drive motor 16 of the dissolving devices 4,
a frequency converter 17 as a resolution function sensor 10,
a dispenser 22 at a dispensing side of the dispensing means 5 for dispensing disintegrated material from the bale breaker 1, and
a discharge screw 28 that transports the disintegrated material between the disintegrators 4 and the dispenser 22 in the discharge direction A.

In the further embodiment of the bale breaker 1 according to FIG. 34, the disintegrating chain 15 is provided for transporting a bale (not shown) or parts thereof to be disintegrated in a bale space 39 to a disintegrating roller 38 along the disintegrating direction Z. The disintegrating chain 15 is provided for transporting the bale (not shown) or parts thereof in a bale space 39 to a disintegrating roller 38. Further, a discharge switch (not shown) and/or a discharge function sensor (not shown) may also be provided according to the previously described embodiments.

The further embodiment of the bale breaker 1 according to FIG. 34 may also have a discharge belt (possibly not visible), with which the disintegrated material can be transported from the disintegrating means 4 to the discharge screw 28 and also dedusted. Preferably, however, the pulping roller 39 is arranged above a part—in FIG. 34 above the left-hand end region—of the discharge screw 28, so that pulped material simply falls from the pulping roller 39 into the discharge screw 28 and is transported by the latter to the dispenser 22.

The dispenser 22 is tubular and, for safety reasons, has an axial length of preferably 80 cm or more, which corresponds to a maximum arm length of an operator, so as to prevent the operator from reaching with his hand from the free open dispensing end 40 to the discharge screw 28 and injuring himself there.

The skilled person may suitably select, provide for and design the remaining components of the bale breaker 1 according to FIG. 34 in accordance with the previously described embodiments shown in the remaining figures of the drawing and within the scope of the technical teachings of the entire present application.

The bale breaker 1 according to the invention, and thus according to all embodiments discussed herein, is particularly and advantageously designed and dimensioned to break up so-called small high-pressure bales. “Small” bales means bale dimensions of about, 45 cm to 50 cm in width, about 37 cm to 42 cm in height and a length of up to 1.2 m.

Furthermore, the preferred mode of operation of the bale breaker 1 according to the invention is preferably generally such that the control means (9) are designed to control the feed drive means 7, if necessary, in dependence on at least one predetermined detection result from the at least one opening function sensor 10 and/or the at least one output function sensor 34, which indicates a malfunction or disturbance or a malfunction or disturbance in progress by the bale 2 at the opening means 4 or at the output devices 5, in such a way that the bale 2 or already comminuted material is temporarily moved away from the dissolving devices 4 against the feed direction Z or against a dedusting direction E, or is temporarily moved more slowly in the feed direction Z towards the dissolving devices 4 or more slowly in the dedusting direction E in the output devices 5.

Further preferred embodiments result from the information in DE 20 2016 008 248 U1, originating from EP 3 078 260 A1, in EP16000806.6, originating from WO2019/185078, whereby these embodiments and their individual features are to be combined with the bale lifter provided according to the invention to the extent that this is technically possible and reasonable, which is readily recognizable to a person skilled in the art.

On the basis of the embodiment examples in the description and in the drawing, the invention is merely illustrated by way of example and is not limited thereto, but includes all variations, modifications, substitutions and combinations which the person skilled in the art can take from the present documents, in particular in the context of the claims and the general representations in the introduction to this description as well as the description of the embodiment examples, and combine with his expert knowledge as well as the prior art. In particular, all individual features and embodiments of the invention can be combined.

### LIST OF REFERENCE SIGNS

1 Bale breaker
2 Bales of hay, straw, litter and/or forage
3 Support devices
4 Unraveling devices
5 Dispensing equipment
6 Feeding devices
7 Feeding drive units
8 Dissolving drive units
9 Control devices
10 Resolution function sensor
11 Bottleneck
12 Driver
13 Carrier
14 Conveyor belt
15 Dissolving chain
16 Drive motor of the pulping equipment
17 Frequency converter
18 Channel
19 Belts
20 U-profiles
21 Belts
22 Dispenser
23 End wall
24 Discharge belt
25 Dust removal duct
26 Carrying devices
27 Driving tines
28 Discharge screw
29 Bottom side of discharge belt 24
30 Bottom side of the dedusting channel 25
31 Perforated plates
32 Collecting container or dust container
33 Discharge switch
34 Discharge function sensor
35 Dust collector
36 Loosening devices
37 Pin
38 Output end
39 Unraveling roller
40 Bale chamber
A Discharge direction
E Dedusting direction
L Breaking direction
S Supply air flow
Z Feed direction

1. A bale breaker (1) for a bale (2) of hay, straw, litter and/or fodder, comprising support means (3) for the bale (2) and opening means (4) adapted to open hay, straw, litter and/or fodder from a bale (2) provided on the support means (3) and to transport it to discharge means (5) arranged downstream of the opening means (4), wherein feed means (6) for feeding a bale (2) provided on the support means (3) in a feed direction (Z) towards the disintegrating means (4) are associated with the support means (3), and wherein feed drive means (7) for driving the feed means (6) and disintegrating drive means (8) for driving the disintegrating means (4) are further provided,
wherein control devices (9) are assigned to the feed drive devices (7) and/or to the opening drive devices (8) and/or to the output devices (5), which control devices (9) are designed to control the feed drive devices (7) and/or the opening drive devices (8) and/or the output devices (5) in such a way that a malfunction or disturbance, such as in particular a jam or a blockage by the bale (2), in particular at the opening devices (4) and/or the output devices (5), is avoided or eliminated.

2. Bale breaker (1) according to claim 1, wherein the control devices (9) are assigned at least one breaking function sensor (10) at the breaking drive devices (8) and/or one output function sensor (34) to the output devices (5) and the control devices (9) are designed to control the feed drive devices (7) and/or the opening drive devices (8) as a function of at least one predetermined detection result of the at least one opening function sensor (10) and/or of the at least one output function sensor (34), which indicates a malfunction or disturbance or an imminent malfunction or disturbance by the bale (2) at the opening devices (4) or at the output devices (5), in such a way that the malfunction or disturbance is counteracted in a secondary manner, wherein, if appropriate each resolution function sensor (10) and output function sensor (34) is preferably a torque sensor, a motion sensor, a temperature sensor, a current or voltage sensor or a switch.

3. Bale breaker (1) according to claim 1, wherein the control means (9) are designed to control the feed drive means (7), optionally in dependence on at least one predetermined detection result from the at least one breaker function sensor (10) and/or the at least one output function sensor (34), which indicates a malfunction or disturbance or an imminent malfunction or disturbance by the bale (2) at the breaker means (4) or at the output means (5), respectively, in such a way that the bale (2) or already broken material is temporarily fed in the opposite direction to the feed direction (Z) from the breaker means (4) or at the output means (5), respectively, at the output devices (5), in such a way that the bale (2) or already comminuted material is temporarily moved away from the dissolving devices (4) against the feed direction (Z) or against a dedusting direction (E), or is temporarily moved more slowly in the feed direction (Z) towards the dissolving devices (4) or is moved more slowly in the dedusting direction (E) in the output devices (5).

4. Bale breaker (1) according to claim 1, wherein a bottleneck (11) is connected upstream of the output devices (5) with respect to the feed direction (Z), which bottleneck is preferably formed by the opening devices (4) or is assigned to the opening devices (4) and, in particular, is connected upstream.

5. Bale breaker (1) according to claim 1, wherein the disintegrating devices (4) contain disintegrating devices (36), in particular possibly in the region of the bottleneck (11), for disintegrating lumps, pieces, lumps or lumps released from the bale (2).

6. Bale breaker (1) according to claim 1, wherein the opening devices (4) contain knife-, blade-, hook-, comb- or rod-shaped carriers (12), several of which are attached to a common rod-shaped carrier (13) and are in particular integrally formed.

7. Bale breaker (1) according to claim 1, wherein the discharge devices (5) contain dedusting means, in particular a dedusting channel (25), which preferably contains at its channel underside (29) at least one perforated plate (31), through which undesirable material, such as sand, sol, clay, etc., is separated and in which a discharge belt (24) of the discharge devices (5) runs.

8. Bale breaker (1) according to claim 1, wherein a discharge belt (24) of the discharge devices (5) as entraining devices (26), in addition to entraining tines (27), also comprises dust entrainers (35) and preferably devices are associated with the discharge devices (5) by means of which an air flow is generated preferably transversely to the dust removal direction (E) from a discharge belt (24) of the discharge devices (5) to the at least one perforated plate (31) of the dust removal channel (25) in order to remove sand, sol, clay etc. from the hay, straw, litter and/or fodder through the perforated plate (31) from the dust removal channel (25). from the hay, straw, litter and/or fodder through the perforated plate (31) out of the dust removal channel (25).

9. Bale opening method, in which a bale (2) of hay, straw, litter and/or fodder is transported on support devices (3) by means of their feed devices (6) driven by feed drive devices (7) to opening devices (4) driven by opening drive devices (8), which opening devices (4) release hay, straw, litter and/or fodder from the bale (2) and transport it to discharge devices (5), wherein the feed drive devices (7) and/or the unraveling drive devices (8) and/or the dispensing devices (5) are controlled by means of control devices (9) in such a way that a malfunction or disturbance, such as in particular a jam or blockage by the bale (2), in particular at the unraveling devices (4) and/or the dispensing devices (5), is avoided or eliminated.

10. Bale opening method according to claim 9, wherein a bale breaker (1) according to claims 2 to 8 is operated as intended.
